(19) United States
(12) Patent Application Publication
(10) Pub. No.: US 2014/0238569 A1
(43) Pub. Date: Aug. 28, 2014

(54) LIGHTWEIGHT TIRE

(71) Applicant: Hervé Ferigo, Clermont-Ferrand Cedex 9 (FR)

(72) Inventor: Hervé Ferigo, Clermont-Ferrand Cedex 9 (FR)

(21) Appl. No.: 14/233,965

(22) PCT Filed: Jul. 17, 2012
(86) PCT No.: PCT/EP2012/063990

§ 371 Date: Apr. 10, 2014

Related U.S. Application Data
(60) Provisional application No. 61/550,863, filed on Oct. 24, 2011.

(30) Foreign Application Priority Data
Jul. 22, 2011 (FR) 1156683

(51) Int. Cl. B60C 3/04

(52) U.S. Cl. CPC B60C 3/04
USPC 152/454; 157/1.1

(57) ABSTRACT

Tire with a maximum axial width SW and axial width RW at the beads, comprising a crown reinforcement of width TW and a radial carcass reinforcement, in which tire, when it is fitted onto its mounting rim and inflated to its service pressure and equilibrium, the following conditions are satisfied: TW/SW≦75%, TW/RW≦85% and X/SH≦50%, where X is the radial height at which the tire has its maximum axial width and SH denotes the radial height of the tire; Y/SH≧80%, where Y is the radial height of the carcass reinforcement at the end of the crown reinforcement; and Z/SH≧90%, where Z denotes the radial height of the carcass reinforcement, and in which the absolute value of the angle α between the tangent to the carcass reinforcement at the points of the carcass reinforcement having the same axial positions as the axial ends of the crown reinforcement and the axial direction is less than or equal to 22°.

### RELATED APPLICATIONS

This application is a U.S. National Phase Application Under 35 USC 371 of International Application PCT/EP2012/063990 Filed Jul. 17, 2012.

This application claims the priority of French Application No. 11/56683 filed Jul. 22, 2011 and U.S. Provisional Appln. No. 61/550,863 filed Oct. 24, 2011, the entire content of both of which are hereby incorporated by reference.

### FIELD OF THE INVENTION

The present invention relates to the radial tires for land vehicles and more particularly to radial tires for passenger vehicles. The invention relates most particularly to lightweight tires.

### BACKGROUND

Research on tires serving to reduce the energy consumption of a vehicle is presently assuming increasing importance. Among the promising approaches explored by tire designers, mention may be made of reducing the rolling resistance of tires, especially by the use of low-hysteresis materials, but also reducing the weight of tires. It has been proposed to reduce the weight of tires by reducing the thicknesses of material and the densities of the reinforcing elements (use of textile cords) or of the rubber compounds, or by using reinforcing elements enabling certain volumes of internal rubber compounds, for example in the region of the bead, to be reduced. Such tires are discussed for example in U.S. Pat. No. 6,082,423 and in the documents cited therein.

The weight reduction obtained is generally limited because the measures taken to reduce weight also result in tires having reduced structural rigidity, shorter wear lifetimes, increased noise emission and reduced endurance.

Another way of reducing the mass of a tire consists in generally reducing its dimensions. Of course, such a reduction is not without consequence on the service capability of the tire, its wear lifetime and the endurance of its structure for a given service load on a wheel of the vehicle. International standards such as those of the ETRTO (European Tire and Rim Technical Organisation) or JATMA (Japan Automobile Tire Manufacturers Association) define, for each nominal dimension, the physical dimensions of the tire, such as its sectional height and its sectional width when fitted onto a rim of given diameter and width. They also define a “load capacity” of the tire, that is to say the maximum admissible static load on a wheel of the vehicle at a defined service pressure.

In these standards, the load capacities are deduced from the nominal dimensions using semi-empirical relationships. These relationships set a maximum static deflection (normalized by the dimensions), of a tire and are based on a standard geometry of the section profiles of the tires of the current technology. They predict that the load capacity of tires of course decreases when, all other things being equal, the section height or width decreases.

However, these standards leave the designer with certain degrees of freedom regarding the dimensions of the section profile that it is possible to use in the context of reducing the mass and rolling resistance of a tire. Most of the mass of a tire and most of its rolling resistance stem from the region of its crown. Reducing the width of the crown would therefore result in an almost proportional increase in the contribution of the crown to the mass and, as experience has shown, an increase in its contribution to rolling resistance.

### SUMMARY OF THE INVENTION

An objective of the present invention is, for a nominal size of a given tire, when fitted onto a given mounting rim, and at a given service pressure, to make the best possible use of the design of the tire geometry in order to reduce the weight of the tire and to reduce its rolling resistance, while maintaining its main performance characteristics, in particular its load capacity and its resistance to unseating.

This objective is achieved by a tire having a rotation axis and comprising:

two beads designed to come into contact with a mounting rim, each bead comprising at least one annular reinforcing structure, thereby defining a mid-plane perpendicular to the rotation axis of the tire and being located equidistant from the annular reinforcing structures of each bead, the annular reinforcing structures having, in any radial cross section, a radially innermost point;

two side walls extending the beads radially outwards, the two side walls joining in a crown comprising a crown reinforcement, wherein the crown reinforcement has two axial ends, said crown reinforcement being surmounted by a tread;

at least one carcass reinforcement extending from the beads through the side walls as far as the crown, the carcass reinforcement comprising a plurality of radially oriented carcass reinforcement elements and being anchored in the two beads by an upturn around the annular reinforcing structure,

wherein, when the tire is fitted onto the mounting rim and inflated to its service pressure:

the tire has a maximum axial width SW such that the ratio TW/SW≦75% (and preferably TW/SW≦73%), where TW denotes the axial distance between the two axial ends of the crown reinforcement, the maximum axial width SW being reached at a radial distance X from the radially innermost point of the annular reinforcing structures;

the axial distance RW of the two points of intersection of the axial direction passing through the radially innermost point of the annular reinforcing structures with the external surface of the tire is such that TW/RW≦85% (and preferably TW/RW≦83%);

the tire satisfies the following three conditions: X/SH≦50%, Y/SH≧80% and Z/SH≧90%, where SH denotes the distance between the radially outermost point of the tire and the radially innermost point of the annular reinforcing structures, Y denotes the radial distance between (i) the points of the carcass reinforcement having the same axial positions as the axial ends of the crown reinforcement and (ii) the radially innermost point of the annular reinforcing structures, and Z denotes the radial distance between the radially outermost point of the carcass reinforcement and the radially innermost point of the annular reinforcing structures;

the absolute value of the angle α (alpha) between the tangent to the carcass reinforcement at the points of the carcass reinforcement having the same axial positions as the axial ends of the crown reinforcement and the axial direction is less than or equal to 22°; and

at any point on the carcass reinforcement, the radius of curvature ρ is such that

$$ρ = \frac{{R}_{S}^{2} - {R}_{E}^{2}}{2 R} ,$$

where R_{S} is the radial distance between the rotation axis of the tire and the radially outermost point of the carcass reinforcement, R_{E} is the radial distance between the rotation axis of the tire and the axial position where the tire reaches its maximum axial width SW, and R is the radial distance between the rotation axis of the tire and the point in question on the carcass reinforcement.

Preferably, the tire has only a single carcass reinforcement so as to reduce its weight.

The invention also relates to an assembly formed by a mounting rim and a tire as described above.

### BRIEF DESCRIPTION OF THE DRAWINGS

FIG. 1 shows a prior art tire.

FIG. 2 shows a partial perspective view of a prior art tire.

FIG. 3 shows, in radial section, one half of a tire according to an embodiment of the invention.

FIG. 4 shows part of the tire of FIG. 3.

FIG. 5 illustrates the parameters used to describe an inflated carcass reinforcement in equilibrium.

### DETAILED DESCRIPTION OF THE FIGURES

When employing the term “radial”, a distinction should be made between several different uses of the word by a person skilled in the art. Firstly, the expression refers to a radius of the tire. It is in this sense that a point P1 is said to be “radially inside” a point P2 (or “radially to the inside” of point P2) if it is closer to the rotation axis of the tire than point P2. Conversely, a point P3 is said to be “radially outside” a point P4 (or “radially to the outside” of point P4) when it is further away from the rotation axis of the tire than point P4. The expression “radially inwardly (or outwardly)” means going towards smaller (or larger) radii. When distances are referred to as radial distances, this meaning of the term also applies.

A thread or a reinforcement is said to be “radial” when the thread or reinforcing elements of the reinforcement make an angle of not less than 80° but not exceeding 90° with the circumferential direction. It should be pointed out, that in the present document, the term “thread” should be understood in a very general sense and comprises threads in the form of monofilaments, multifilaments, a cord, a yarn or an equivalent assembly, irrespective of the material constituting the thread or the surface treatment for promoting adhesion to the rubber.

Finally, the term “radial section” or “radial cross section” is understood here to mean a section or cross section in a plane that contains the rotation axis of the tire.

An “axial” direction is a direction parallel to the rotation axis of the tire. A point P5 is said to be “axially inside” a point P6 (or “axially to the inside” of point P6) if it is closer to the mid-plane of the tire than point P6. Conversely, a point P7 is said to be “axially outside” a point P8) or “axially to the outside” of point P8) if it is further away from the mid-plane of the tire than point P8. The “mid-plane” of the tire is the plane perpendicular to the rotation axis of the tire lying equidistant from the annular reinforcing structures of each bead.

A “circumferential” direction is a direction perpendicular both to a radius of the tire and to the axial direction.

In the context of this document, the expression “rubber compound” denotes a rubber compound comprising at least one elastomer and at least one filler.

The “external surface” of the tire denotes here the surface of the tire which, when the tire is fitted onto a mounting rim and inflated to its service pressure, is in contact with the atmosphere (or with the mounting rim), as opposite to its “internal surface”, which is in contact with the inflation gas.

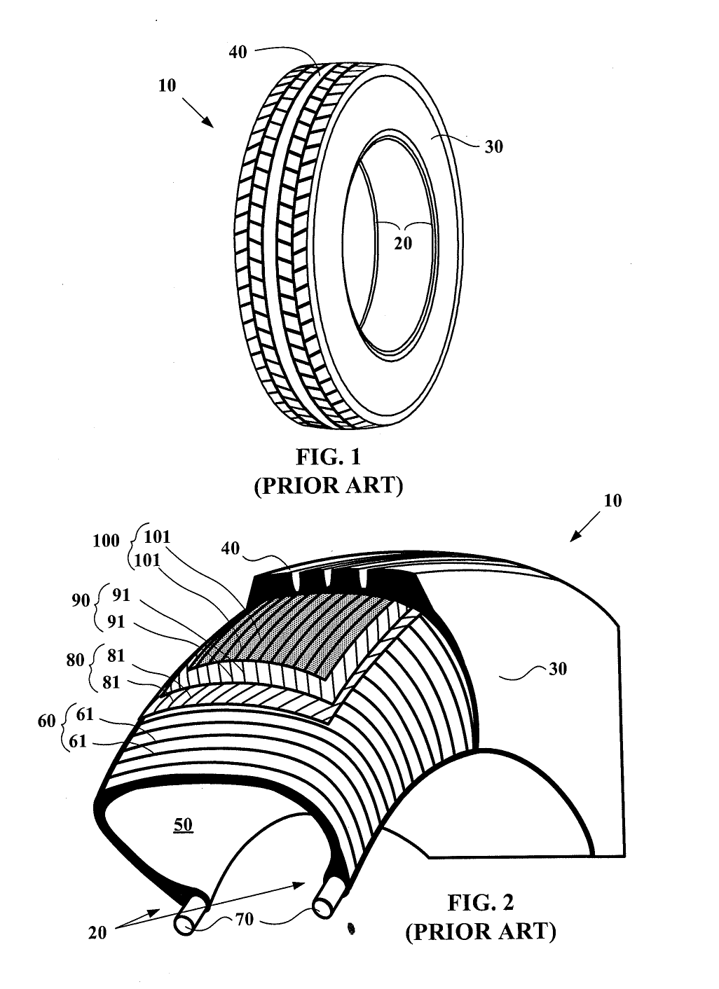

FIG. 1 shows schematically a prior art tire 10. The tire 10 comprises a crown, having a crown reinforcement (not visible in FIG. 1) surmounted by a tread 40, two sidewalls 30 extending the crown radially inwards, and two beads 20 radially inside the sidewalls 30.

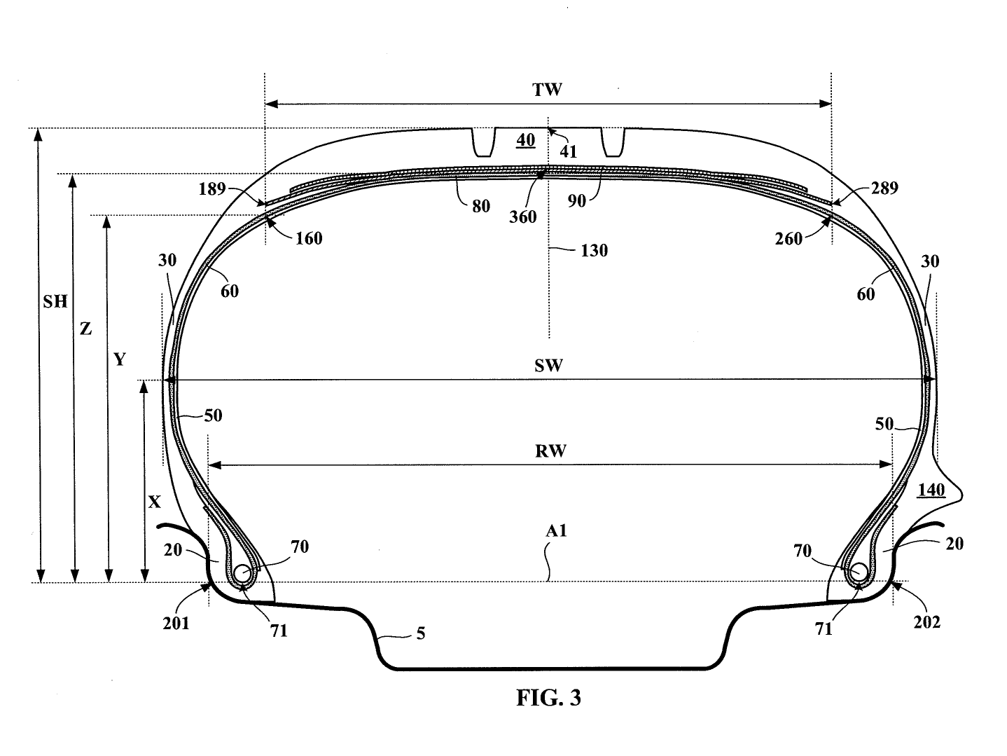

FIG. 2 shows schematically a partial perspective view of a prior art tire 10 and illustrates the various components of the tire. The tire 10 comprises a carcass reinforcement 60 consisting of threads 61 embedded in a rubber composition, and two beads 20 each comprising annular reinforcing structures 70 which hold the tire 10 on the rim (not shown). The carcass reinforcement 60 is anchored in each of the beads 20. The tire 10 further includes a crown reinforcement comprising two plies 80 and 90. Each of the plies 80 and 90 is reinforced by filamentary reinforcing elements 81 and 91 which are parallel in each ply and crossed from one layer to the next, making angles of between 10° and 70° to the circumferential direction. The tire further includes a hooping reinforcement 100 placed radially to the outside of the crown reinforcement, this hooping reinforcement being formed from circumferentially oriented reinforcing elements 101 wound in a spiral. A tread 40 is placed on the hooping reinforcement; it is via this tread 40 that the tire 10 comes into contact with the road. The tire 10 shown is a “tubeless” tire: it includes an “inner liner” 50 made of a butyl-based rubber composition impermeable to the inflation gas and covering the internal surface of the tire.

FIG. 3 shows, in radial cross section, one half of a tire according to an embodiment of the invention. This tire has a rotation axis (not shown) and comprises two beads 20 designed to come into contact with a mounting rim 5. Each bead has an annular reinforcing structure, in this case a bead wire 70. Here, the two bead wires 70 have the same diameter and two points 71 qualify as radially innermost point of the bead wires 70.

The tire 10 has two side walls 30 extending the beads radially towards the outside, the two side walls 30 joining in a crown having a crown reinforcement formed by the plies 80 and 90. The crown reinforcement has two axial ends 189 and 289. In the present case, these ends coincide with the axial ends of the radially inner ply 80, but this is not an essential feature of the invention—it is also possible to provide a radially outer ply 90 that extends axially beyond the inner ply, on only one side of the mid-plane 130, or on each side of this plane, without departing from the scope of the invention. The crown reinforcement is surmounted by a tread 40. In principle, it would be possible also to provide a hooping reinforcement, such as the hooping reinforcement 100 of the tire shown in FIG. 2, but in the present case the weight of the tire was minimized by not providing a hooping reinforcement.

The tire 10 comprises a single radial carcass reinforcement 60 extending from the beads 20 through the side walls 30 to the crown, the carcass reinforcement 60 comprising a plurality of carcass reinforcing elements. It is anchored in the two beads 20 by an upturn around the bead wire 70.

When the tire 10 is fitted onto the mounting rim 5 and inflated to its service pressure, it meets several criteria.

Firstly, it has a maximum axial width SW such that the ratio TW/SW≦75%, where TW denotes the axial width of the crown reinforcement, i.e. the axial distance between the two axial ends 189 and 289 of the crown reinforcement. In this case, TW/SW=73%. The maximum axial width SW is reached at a radial distance X from the radially innermost point of the annular reinforcing structures. It should be pointed out that when determining the width SW, no account is taken of protrusions such as the protecting rib 140. It should also be pointed out that, when the carcass reinforcement has a significant axial thickness, it is appropriate to measure the maximum axial width SW at the neutral fiber of the reinforcing elements 61 (see FIG. 2) constituting it.

Secondly, the axial distance RW of the two points of intersection 201 and 202 of the axial direction A1 passing through the radially innermost point(s) 71 of the bead wires 70 with the external surface of the tire is such that TW/RW≦85%. In this case TW/RW=83%.

Thirdly, X/SH≦50% (and preferably, X/SH≦45%), where SH denotes the distance between the radially outermost point 41 of the tire, and the radially innermost point 71 of the annular reinforcing structures 70. In this case, X/SH=50%.

Fourthly, Y/SH≧80%, where Y denotes the radial distance between (i) the points 160 and 260 of the carcass reinforcement 60 having the same axial positions as the axial ends 189 and 289 of the crown reinforcement and (ii) the radially innermost point 71 of the annular reinforcing structures 70, SH being defined as above. In this case, Y/SH=80%.

Fifthly, Z/SH≧90%, where Z denotes the radial distance between the radially outermost point 360 of the carcass reinforcement 60 and the radially innermost point 71 of the annular reinforcing structures 70, SH being defined as above. In this case, Z/SH=90%.

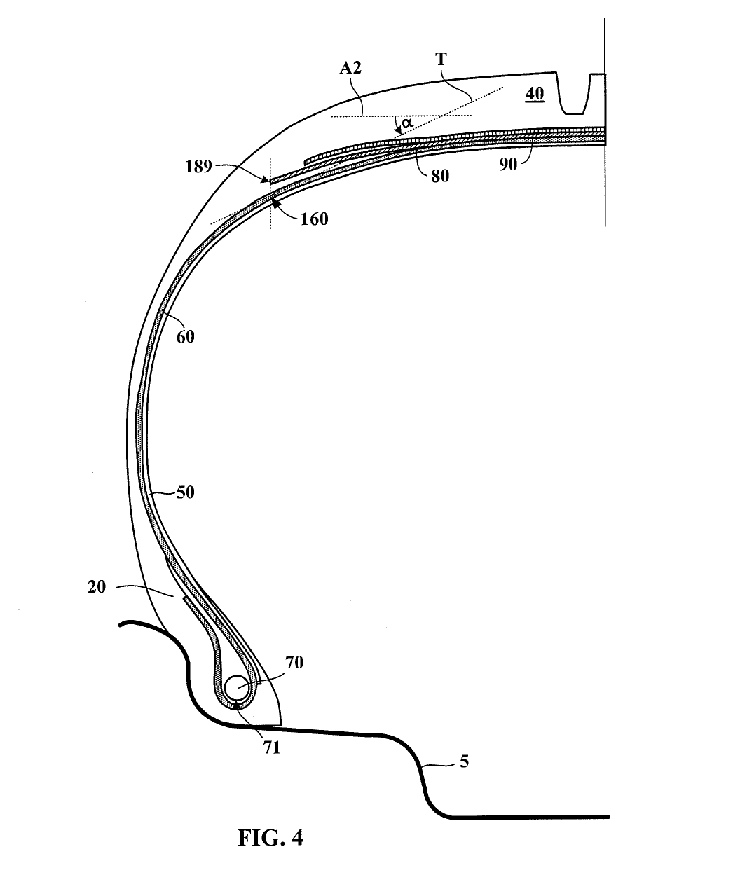

Sixthly, the absolute value of the angle α (alpha)—indicated in FIG. 4, between the tangent T to the carcass reinforcement 60 at the points 160 and 260 of the carcass reinforcement 60 having the same axial positions as the axial end points 189 and 289 of the crown reinforcement and the axial direction, is less than or equal to 22°.

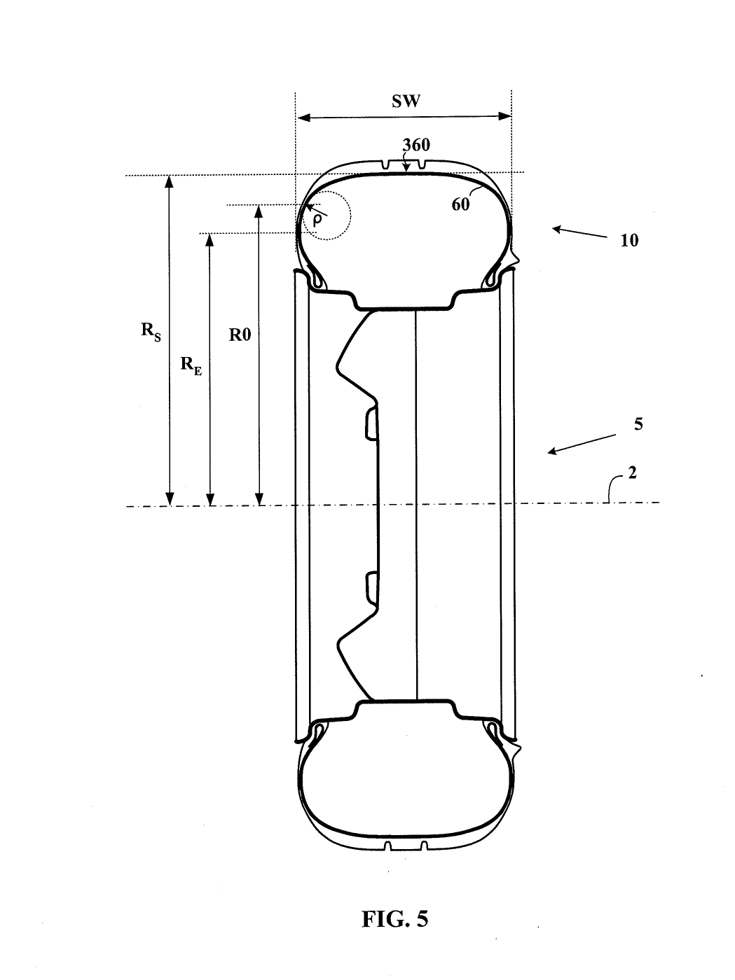

Finally, at any point on the carcass reinforcement 60, the radius of curvature ρ is such that

$$ρ = \frac{{R}_{S}^{2} - {R}_{E}^{2}}{2 R} ,$$

where R_{S} is the radial distance between the rotation axis of the tire and the radially outermost point of the carcass reinforcement 60, R_{E} is the radial distance between the rotation axis of the tire and the axial position where the tire reaches its maximum axial width SW, and R is the radial distance between the rotation axis of the tire and the point in question on the carcass reinforcement. These values are indicated in FIG. 5, together with the radius of curvature ρ for a radial position R=R0. The reference 2 indicates here the rotation axis of the tire 10.

As is well known to those skilled in the art, the latter criterion corresponds to the equilibrium condition for an inflated radial carcass reinforcement. It serves in particular to differentiate the invention from fortuitous prior art representing uninflated tires for which some of the criteria listed above would be fulfilled in the uninflated state, but which would no longer be fulfilled if the tire were to be inflated and the carcass reinforcement were to be considered in the equilibrium state. An example of this is shown in FIG. 1 of document WO 1999/022952 which shows a tire that is manifestly not in equilibrium, as the fold in the carcass reinforcement close to the ends of the crown reinforcement shows.

A tire according to an embodiment of the invention, of 205/55 R 16 size, was compared with a Michelin Energy Saver reference tire of the same size. The following table gives the essential geometric parameters:

TABLE I

| | | Tire according to an |
|---|---|---|
| | | embodiment of the |
| | Reference tire | invention |
| TW/RW | 1.07 | 0.83 |
| TW/SW | 0.82 | 0.73 |
| X/SH | 0.53 | 0.50 |
| Y/SH | 0.89 | 0.90 |
| Z/SH | 0.82 | 0.90 |
| α (alpha) | 22 | 22 |

The tire according to an embodiment of the invention is 1.8 kg lighter than the reference tire (weighing 6.2 kg instead of 8.0 kg), but its rolling resistance at 90 km/h is 1.96 kg/T lower and its main performance characteristics are equivalent, in particular its load capacity corresponding to an index of 91 (603 daN) and its ability not to unseat.

1. A tire having a rotation axis and comprising:
two beads configured to come into contact with a mounting rim, each bead comprising at least one annular reinforcing structure, thereby defining a mid-plane perpendicular to the rotation axis of the tire and being located equidistant from the annular reinforcing structures of each bead, the annular reinforcing structures having, in any radial cross section, a radially innermost point;
two side walls extending the beads radially outwards, the two side walls joining in a crown comprising a crown reinforcement wherein the crown reinforcement has two axial ends, said crown reinforcement being surmounted by a tread;
at least one carcass reinforcement extending from the beads through the side walls as far as the crown, the carcass reinforcement comprising a plurality of radially oriented carcass reinforcement elements and being anchored in the two beads by an upturn around the annular reinforcing structure;
wherein, when the tire is fitted onto the mounting rim and inflated to its service pressure:
the tire has a maximum axial width SW such that the ratio TW/SW≦75%, where TW denotes the axial distance between the two axial ends of the crown reinforcement, the maximum axial width SW being reached at a radial distance X from the radially innermost point of the annular reinforcing structures;
the axial distance RW of the two points of intersection of the axial direction passing through the radially innermost point of the annular reinforcing structures with the external surface of the tire is such that TW/RW≦85%;
the tire satisfies the following three conditions: X/SH≦50%, Y/SH≧80% and Z/SH≧90%, where SH denotes the distance between the radially outermost point of the tire and the radially innermost point of the annular reinforcing structures, Y denotes the radial distance between (i) the points of the carcass reinforcement having the same axial positions as the axial ends of the crown reinforcement and (ii) the radially innermost point of the annular reinforcing structures, and Z denotes the radial distance between the radially outermost point of the carcass reinforcement and the radially innermost point of the annular reinforcing structures;
the absolute value of the angle α (alpha) between the tangent to the carcass reinforcement at the points of the carcass reinforcement having the same axial positions as the axial ends of the crown reinforcement and the axial direction is less than or equal to 22°; and
at any point of the carcass reinforcement, the radius of curvature ρ is such that
$$ρ = \frac{{R}_{S}^{2} - {R}_{E}^{2}}{2 R} ,$$
where R_{S} is the radial distance between the rotation axis of the tire and the radially outermost point of the carcass reinforcement, R_{E} is the radial distance between the rotation axis of the tire and the axial position where the tire reaches its maximum axial width SW, and R is the radial distance between the rotation axis of the tire and said point of the carcass reinforcement.

2. The tire of claim 1, wherein the ratio TW/SW is less than or equal to 73%.

3. The tire of claim 1, wherein the ratio TW/RW is less than or equal to 83%.

4. An assembly formed by a mounting rim and a tire according to claim 3.

5. An assembly formed by a mounting rim and a tire according to claim 1.

6. An assembly formed by a mounting rim and a tire according to claim 2.
